(19) United States
(12) Patent Application Publication
(10) Pub. No.: US 2014/0225320 A1
(43) Pub. Date: Aug. 14, 2014

(54) MULTICOMPONENT CUTTING BOARD

(71) Applicant: ANGELO GOTSIS, HILLSIDE, NJ (US)

(72) Inventor: ANGELO GOTSIS, HILLSIDE, NJ (US)

(21) Appl. No.: 14/178,710

(22) Filed: Feb. 12, 2014

Related U.S. Application Data
(60) Provisional application No. 61/764,790, filed on Feb. 14, 2013.

(51) Int. Cl. A47J 47/00

(52) U.S. Cl. CPC A47J 47/005
USPC 269/14; 269/16

(57) ABSTRACT

The present disclosure provides for a cutting board and food preparation and waste removal system. The cutting board has a top cutting surface with a storage area underneath. In this storage area, trays are kept that may be slid in or out. Additionally, the trays are removable. The trays can be used to hold and facilitate the removal of food waste or may be used to hold cut or chopped food. Further included is a swiper which can be used to clean the cutting surface by using a blade to direct food and food waste into the trays. A portion of the handle of the swiper detaches to expose a cutting blade which can be used to chop, cut, and mince food items. Once the food has been cut and the food waste has been cleaned and removed, the entire device can be placed into the dishwasher for thorough cleaning.

### CLAIM OF PRIORITY

This application claims priority to U.S. application Ser. No. 61/764,790 filed on Feb. 14, 2013 the contents of which are herein incorporated by reference in its entirety.

### FIELD OF THE INVENTION

The field of the invention relates to cutting boards using in the kitchen or elsewhere for the preparation and cutting of materials, namely a cutting board designed for kitchen use having multiple functionalities. In particular, to a cutting board designed to be cleaned quickly and easily and having integrated disposal areas as well as a knife sharpener and food item chopper.

### BACKGROUND OF THE INVENTION

Cutting instruments are ubiquitous in any kitchen environment whether it is in a home or a commercial setting. The preparation and consumption of many foods relies on the crushing, chopping, cutting, and mincing power of blades. Instruments, such as knives, are commonly used to achieve these methods of size reduction. Knives, however, are often quite sharp and can be serrated. Thus, their use can easily damage other kitchen items such as countertops and ranges. Alternatively, some harder materials found in the kitchen setting may damage or dull the knives themselves. Hence, a cutting board is typically used when one must chop or cut a particular food item down to the desired size.

Cutting boards are pieces of material that are used as a barrier between a sharpened blade, typically a knife, and the surrounding area. Prevalent cutting board materials comprise plastic, metal, wood, glass, and rubber or some combination thereof. Some materials are more popular in certain settings and depend on which utensils will be used in conjunction with the cutting board. While cutting boards are extremely efficient at providing a barrier between a blade and the surrounding area, cutting boards do have some downfalls. Cutting boards can require routine maintenance, usually to disinfect the cutting board. Many foods, including meats like poultry, can leave behind undesirable bacteria on the cutting board surface. Further, cutting boards can be hard to clean because the blades will put minute grooves in the cutting board surface. While these small cuts make for an increased difficulty in cleaning, these cuts also harbor harmful bacteria and other toxins such as mold and mildew whose removal may be impeded. Additionally, to remove food or food waste from the cutting board, one must pick up the food or food waste with their hands, which is unsanitary, or the individual can carry the cutting board to the desired location with the items still present on the board surface. Again, this can result in spillage of bacteria ridden waste or freshly prepared food which is then contaminated.

Thus, it is necessary to design a cutting board that can be used in food preparation and food waste removal to combat these challenges. It is preferable to have a cutting board that provides storage and resists bacteria and other toxins while making clean up easy and effortless. While various devices are known in the art, their structure and means of operation are substantially different from that of the present disclosure. The other inventions also fail to solve all the problems taught by the present disclosure. The present invention provides for a cutting board that has an antimicrobial cutting surface. Further, the present invention has tools to aid in the cutting of food and subsequent storage of the chopped food and removal of the food waste. At least one embodiment of this invention is presented in the drawings below and will be described in more detail herein.

### SUMMARY OF THE INVENTION

The present invention describes a multifunctional, multicomponent cutting board having a cutting board with a top surface, a bottom surface, and at least one side surface, wherein the at least one side surface has a height and is coupled to the top surface and the bottom surface defining a cavity therebetween; and at least one slidable tray having a bottom surface and a plurality of side surfaces, wherein the at least one slidable tray is sized to be slidably positioned within the cavity of the cutting board.

In another aspect of the invention there is a food preparation and removal system having an antimicrobial cutting board with a top surface, a bottom surface, and two side surfaces, wherein the two side surfaces have a height and are coupled to the top surface and the bottom surface defining a cavity therebetween, wherein the top surface is removable and has at least one graded channel that facilitates the removal of liquid waste from the top surface; two slidable trays having a bottom surface and a plurality of side surfaces, wherein the two slidable trays are sized to be slidably positioned within the cavity of the cutting board and the trays are removable; a knife sharpening tool attached to the top surface or one of the two side surfaces of the cutting board; and a swiper having a handle section and a blade section, wherein the blade section is adapted for cleaning the top surface of the cutting board, wherein a cutting tool is removable from the handle portion of the swiper, wherein the cutting tool has a handle portion and a cutting blade extending therefrom.

Generally, the present invention is a multicomponent, multifunctional cutting board and food preparation system. The main cutting board comprises the top surface whereas the bottom surface and side surface(s) are supporting structures. In some embodiments, the bottom surface may also have a workable cutting board surface like that of the top surface. The whole apparatus then could be flipped over or used in a similar fashion to have a clean cutting board without any clean up. The top surface, or cutting surface, is a preferably a polypropylene material. The top surface has at least one and preferably two channels bearing a U-shape. The channels are graded, or sloped, and help liquid waste to be removed from the top surface and disposed of in the slidable tray(s). The top surface may also be removable. The bottom surface and side surface(s) are preferably a hardened plastic. Along the bottom surface there may be a non-slip surface which may cover the entire outer surface of the bottom surface or may cover only a partial part of the outer surface.

The slidable trays fit slidably within the space between the top surface and the bottom surface and bounded by the side surfaces. The slidable trays may have dividers contained therein which section the tray into multiple bounded areas. Additionally, the slidable trays may have a hinged cover or lid that covers the entire tray or multiple covers covering only a part of the tray. The tray or trays are designed to fit within the cavity formed between the top surface and the bottom surface and if there are multiple trays, the trays may have substantially similar dimensions. The swiper has a handle portion that is ergonomically shaped to fit an individual's hand. The swiper has a blade, which may be beveled, that can be slid along the top surface to either place food or food waste within the slidable trays. When desired, a portion of the handle of the swiper is removable and when removed exposes a cutting blade. The user can then use the existing portion of the handle with this different blade to crush, chop, mince, and so forth a variety of materials.

In general, the present invention succeeds in conferring the following, and others not mentioned, benefits and objectives.

It is an object of the present invention to provide a cutting board that is antimicrobial.

It is an object of the present invention to provide a cutting board that directs the flow of waste run off to desired areas or containers.

It is an object of the present invention to provide a cutting board that is dishwasher safe.

It is an object of the present invention to provide a cutting board that provides for storage of slidable, removable trays.

It is an object of the present invention to provide a cutting board that will not dull knives.

It is an object of the present invention to provide a cutting board that is odor resistant.

It is an object of the present invention to provide a cutting board that provides containers for food storage or food waste disposal.

It is another object of the present invention to provide a cutting board that has an integrated knife sharpening tool.

It is another object of the present invention to provide a cutting board that is used in conjunction with a swiper to efficiently remove waster and clean the cutting surface.

It is another object of the present invention to provide a cutting board that has a non-slip bottom surface to provide a stable work area.

It is yet another object of the present invention to provide a cutting board that is practical and inexpensive.

It is yet another object of the present invention to provide a cutting board that is lightweight and durable.

### BRIEF DESCRIPTION OF THE DRAWINGS

FIG. 1A is a perspective view of an embodiment of the present invention.

FIG. 1B is an exploded perspective view of an embodiment of the present invention showing the multiple components.

FIG. 2A is a side view of the swiper of the present invention with the chopper secured thereto.

FIG. 2B is a side view of the swiper of the present invention with the chopper removed.

FIG. 3 is a perspective view of one of the slidable trays of the present invention.

FIG. 4 illustrates an embodiment of the invention being used as intended.

### DETAILED DESCRIPTION OF THE DRAWINGS

The preferred embodiments of the present invention will now be described with reference to the drawings. Identical elements in the various figures are identified, as far as possible, with the same reference numerals. Reference will now be made in detail to embodiments of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto without deviating from the innovative concepts of the invention.

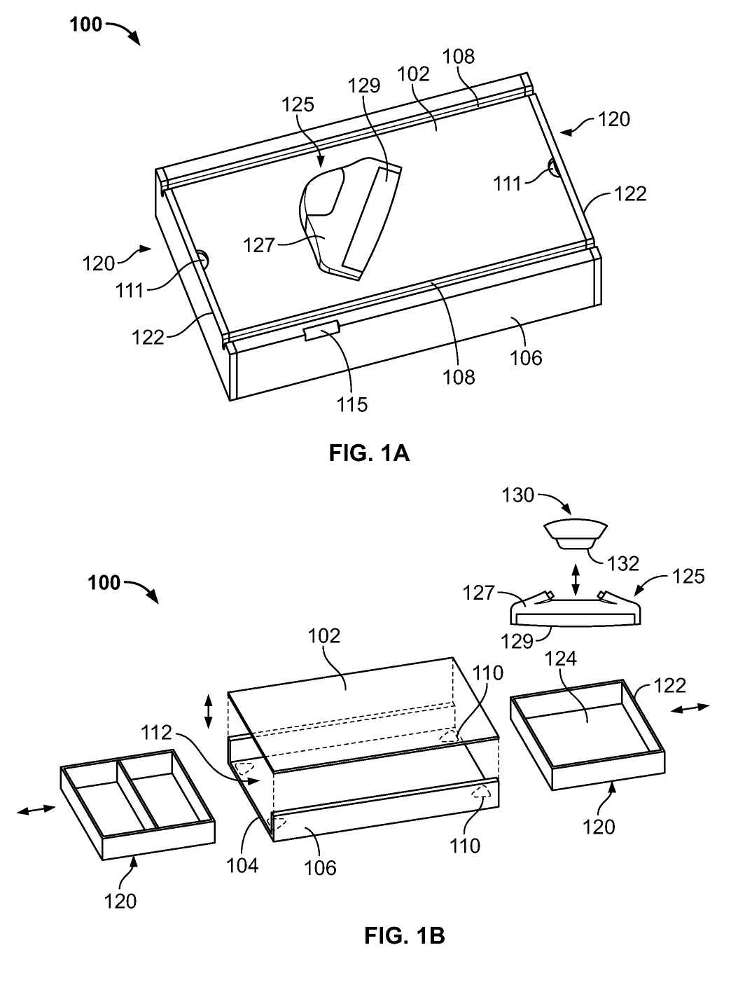

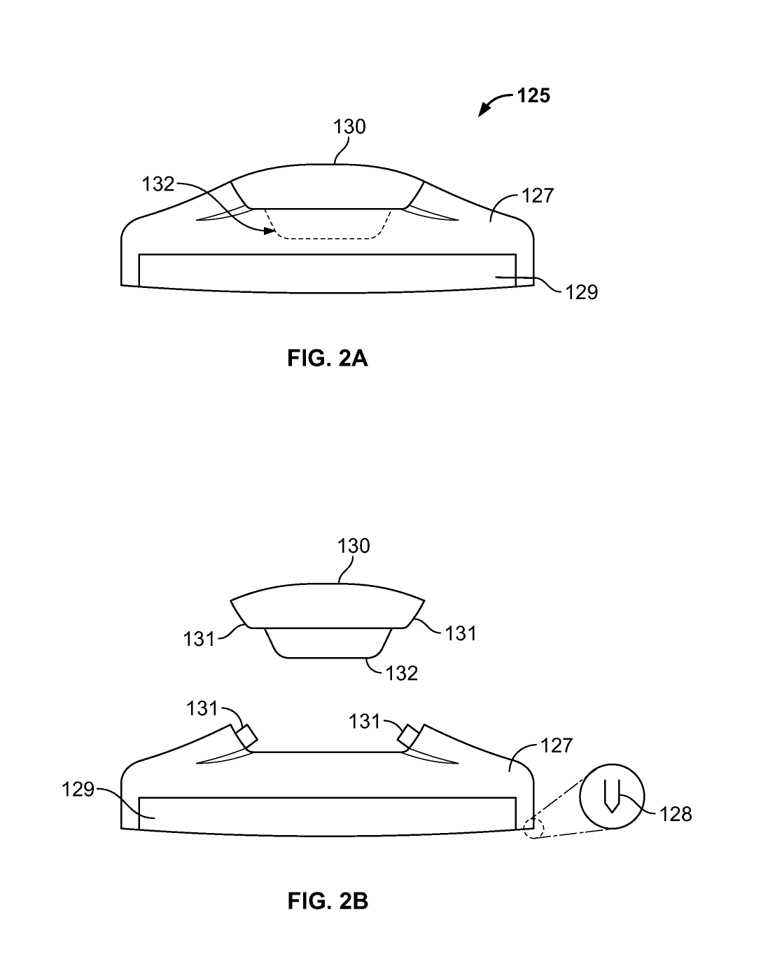

Referring to FIG. 1A, there is one embodiment of the present invention. The cutting board 100 is shown having a top surface 102, a bottom surface 104 (see FIG. 1B), and at least one side surface 106. Preferably, there are two side surfaces 106 which are substantially parallel to one another. The top surface 102 has at least one and preferably two graded channels 108 traversing a length of the top surface 102. Further, the top surface 102 has grooves 111 which assist a user in removing the slidable trays 120. The cutting board 100 has slidable, removable trays 120 which are stored underneath the top surface 102, or cutting surface. In this Figure, one of the sidewalls 122 of the slidable tray 120 is visible. Further, the cutting board 100 has a knife sharpening tool 115 on at least one of the surface of the cutting board 100. The cutting board 100 can be cleaned with a swiper 125. The swiper 125 has a handle section 127 and a blade section 129. The blade section 129 is shaped to efficiently clean the upper surface of food and food waste (see FIG. 2B).

FIG. 1B shows the components of the cutting board 100 in an exploded view demonstrating their interaction with one another. The top surface 102 of the cutting board 100 is a singular piece having a height. The top surface 102 may be removably attached to the side surfaces 106 by way of fasteners, snaps, clips, locks, male/female components and the like or some combination thereof. The bottom surface 104 has non slip areas 110 disposed thereon which prevent the cutting board 100 from sliding during use. The space between the top surface 102 and the bottom surface 104 is defined by the height of the side surfaces 106. Therebetween a cavity 112 is formed which holds the slidable trays 120. The slidable trays 120 may readily slide in or out of the storage position and are removable as well. The slidable trays 120 have a bottom surface 124 and a plurality of sidewalls 122 which fully enclose the bottom surface 124. The swiper 125 has a handle section 127 and a blade section 129. Further, a portion of the handle section 127 is removable which exposes a cutting blade 132. This cutting tool 130 can then be used to chop, dice, mince, or so forth any food item requiring such a reduction in size.

FIG. 2A shows a front view of the swiper 125. The swiper has a handle portion 127 and a blade portion 129. The handle portion 127 is preferably shaped as to provide for easy maneuvering of the blade portion 129 across the top surface. The handle portion 127 further has a cutting tool 130 that resides in a section of the handle portion 127 (see FIG. 2B). The interior of the handle portion 127 is designed to receive the cutting blade 132. In FIG. 2B, the cutting tool 130 has been removed from its storage position in the handle portion 127 of the swiper 125. Visible are the cutting tool 130 with a handle and the cutting blade 132. The cutting blade 132 may be more rounded rather than straight edged as with the swiper 125. This facilitates a rocking, chopping motion that many in the kitchen are accustomed. The cutting tool 130 attaches to the swiper 125 via male/female connectors 131 which hold the cutting tool 130 in place when not in use. The cutting tool 130 simply snaps in or out of the storage position. Additionally, the beveled edge 128 of the swiper blade 129 is shown. This edge provides for easy removal of materials from the top surface of the cutting board.

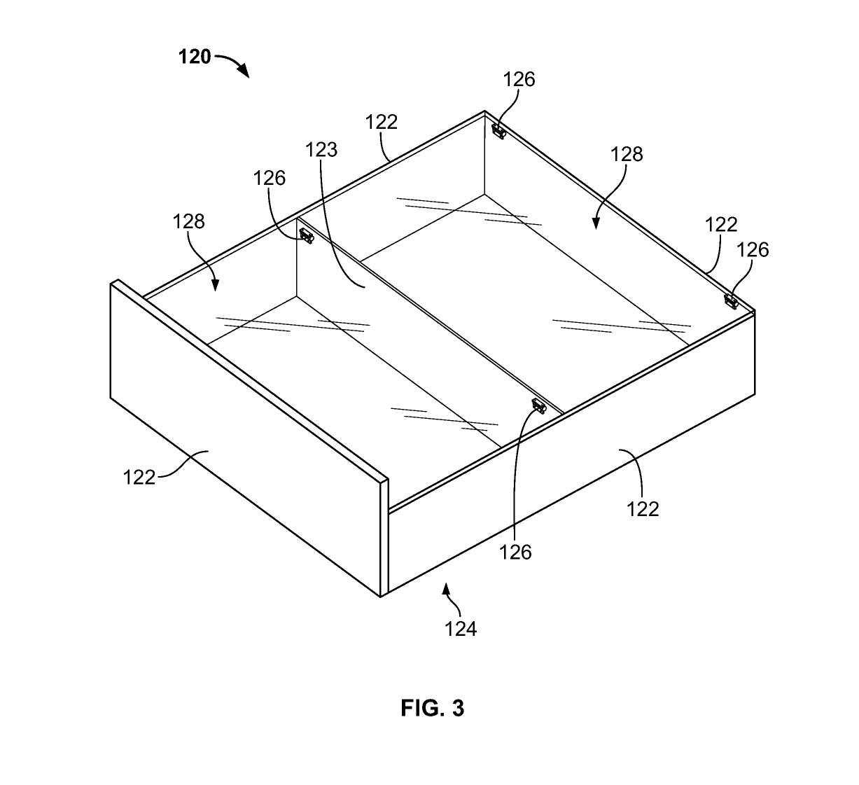

In FIG. 3, the slidable tray 120 is shown from a perspective view. The slidable tray 120 has a bottom surface 124 and a plurality of side surfaces 122 connected to and extending upwards therefrom. Preferably, at least one of the side surfaces 122 has a height greater than the others. This side surface 122 is intended to be the outward facing surface (when placed in a storage position) and this differential in height makes up for the distance between the other side surfaces 122 and the height of the top surface of the cutting board. The slidable tray 120 may have a divider 123 positioned at some point between the side surfaces dividing the interior portion of the slidable tray 120 in to more than one compartment. The number of compartments and dividers 123 may vary in accordance with the intention of the present invention.

The slidable tray 120 may also have a cover 128 or lid that is attached to one of the side surfaces 122 or the divider 123. The cover 128 is preferably connected to these surfaces via a hinge 126 that enables rotational movement of the cover 128 that can be used to cover or uncover the underlying compartments. In the event of there being multiple compartments there may be an individual cover 128 for each compartment each attached by a hinge 126 or other comparable attachment mechanisms. Preferably, the cover(s) 128 are clear or transparent, but may also be translucent or tinted with a particular color. The slidable trays 120 are dishwasher safe.

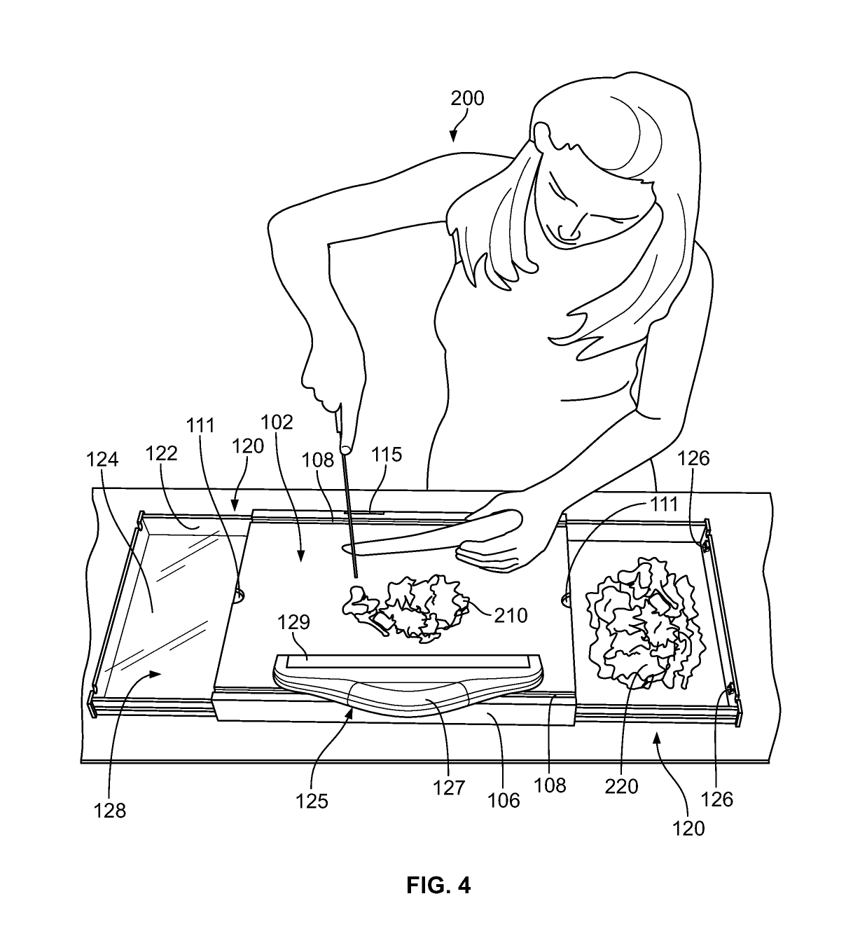

FIG. 4 shows the present invention being used in at least one manner as intended. The cutting board 100 is placed in front of the user 200 (from the user's perspective). The top surface 102 is held in position by the side surfaces 106. The slidable trays 120 have been moved from their storage position and placed where they can receive the chopped food 210 or the food waste 220 as shown. As the user 200 chops the various food items, liquid waste may begin to accumulate on the top surface 102. The graded channels 108 should help direct the flow of such liquids to the slidable trays 120 for easy clean up and disposal. The top surface 102 may also be graded in order to facilitate the flow of any liquid to those graded channels 108.

The grooves 111 along the top surface 102 aid the user 200 in positioning the slidable trays 120. As the user 200 chops the food item on the top surface 102, the food can be placed into either of the slidable trays 120. As shown, some food waste 220 is already in one of the slidable trays 120 for disposal. The other tray 120 has a cover 128 that can be used as a container for the chopped food 210. Both trays 120 may have such a cover 128 and the covers 128 may be removable. The swiper 125 is positioned where it can readily be accessed and used to remove chopped food 210 or food waste 220 to a particular area. If any chopping or cutting instrument dulls, the knife sharpening tool 115 can be used to quickly restore the blade of the knife or other instrument.

Generally, the cutting board 100 and accessories described in FIGS. 1-4 can be used in a household setting or commercial kitchen and any other food preparation area. The cutting board 100 is preferably a plastic including but not limited to polyethylene terephthalate (PET), polyethylene (PE), high-density polyethylene, polyvinyl chloride (PVC), polyvinylidene chloride (PVDC), low-density polyethylene (LDPE), polypropylene (PP), polystyrene (PS), high impact polystyrene (HIPS) and polycarbonate (PC), or any combination thereof. The top surface 102 may comprise any combination of the above and other not named materials, however, it is preferable that the top surface 102 is a non-porous, odor resistant polypropylene. The slidable tray(s) 120 preferably comprise any of the above named compounds, as well as the handle portion 127 of the swiper 125. The blade portion 129 of the swiper 125 is preferably a silicone based material selected for its properties to interact favorably with the top surface 102. The cutting blade 132 is preferably a metal, although a sharpened, hardened plastic, resin, or composite may suffice. Additionally, other various types of materials may be used in constructing the cutting board 100 and the various accessories including composites which may include but are not limited to fiber reinforced plastics, metal composites, carbon fiber, and Kevlar® and the like. Metals may be used comprising numerous lightweight metals such as aluminum and other pure metals as well as various alloys. The materials may be selected with certain safety precautions in mind and to comply with FDA standards relating to materials considered safe for food preparation. Thus, the cutting board is preferably bisphenyl A (BPA) free and dishwasher safe. The cutting board 100 and other materials are preferably antimicrobial, and should at least be antibacterial. An example of an added antibacterial compound is Triclosan, which is commonly used in making antibacterial items that come into contact with food.

The cutting board 100 is sized to be convenient to carry and use by persons of any physical ability, while presenting a large, quality surface area for food preparation. Thus, the materials should be sufficiently durable yet lightweight. The cutting board 100 is sized to preferably be about 40 cm (16 inches) by about 28 cm (11 inches) and to be about 3.8 cm (1.5 inches) in depth. However, the size of the cutting board 100 may generally range from about 13 cm (5 inches) to about 91 cm (36 inches) by about 13 cm (5 inches) to about 76 cm (30 inches) with a depth ranging from about 1.3 cm (0.5 inch) to about 13 cm (5 inches).

What is claimed is:

1. A multifunctional cutting board comprising:
a cutting board having a top surface, a bottom surface, and at least one side surface,
wherein the at least one side surface has a height and is coupled to the top surface and the bottom surface defining a cavity therebetween; and
at least one slidable tray having a bottom surface and a plurality of side surfaces,
wherein the at least one slidable tray is sized to be slidably positioned within the cavity of the cutting board.

2. The multifunctional cutting board of claim 1 wherein there are two slidable trays,
wherein each of the two slidable trays have similar dimensions.

3. The multifunctional cutting board of claim 1 further comprising at least one channel located in the top surface of the cutting board,
wherein the at least one channel is located in proximity to and is substantially parallel to an edge of the cutting board.

4. The multifunctional cutting board of claim 1 wherein at least the top surface comprises an antimicrobial or antibacterial material.

5. The multifunctional cutting board of claim 1 further comprising a knife sharpening tool disposed on a surface of the cutting board.

6. The multifunctional cutting board of claim 1 wherein the at least one slidable tray is removable.

7. The multifunctional cutting board of claim 1 further comprising a swiper,
wherein the swiper has a handle section and a bladed section.

8. The multifunctional cutting board of claim 7 wherein the handle section has a removable section,
wherein the removable section comprises a removable second handle section and a second bladed section,
wherein the second bladed section is adapted for cutting, peeling, dicing, or chopping.

9. The multifunctional cutting board of claim 1 wherein the top surface is removable.

10. A food preparation and removal system comprising:
an antimicrobial cutting board having a top surface, a bottom surface, and two side surfaces,
wherein the two side surfaces have a height and are coupled to the top surface and the bottom surface defining a cavity therebetween,
wherein the top surface is removable and has at least one graded channel that facilitates the removal of liquid waste from the top surface;
two slidable trays having a bottom surface and a plurality of side surfaces,
wherein the two slidable trays are sized to be slidably positioned within the cavity of the cutting board and the trays are removable;
a knife sharpening tool attached to the top surface or one of the two side surfaces of the cutting board; and
a swiper having a handle section and a blade section,
wherein the blade section is adapted for cleaning the top surface of the cutting board,
wherein a cutting tool is removable from the handle portion of the swiper,
wherein the cutting tool has a handle portion and a cutting blade extending therefrom.

11. The food preparation system of claim 10 wherein food waste can be removed from the antimicrobial cutting board and into either of the removable trays using the swiper.

12. The food preparation system of claim 10 wherein the knife sharpening tool is removable.

13. The food preparation system of claim 10 wherein the position of the at least one graded channel is located so that the liquid waste is removed from the top surface into one of the slidable trays.

14. The food preparation system of claim 10 further comprising a non-slip surface that covers all or part of the bottom surface.

15. The food preparation system of claim 10 further comprising a hinged cover coupled to the removable trays.

16. The food preparation system of claim 13 wherein there are two graded channels.

17. The food preparation system of claim 10 wherein the antimicrobial cutting board, slidable trays, swiper, and knife sharpening tool are all dishwasher safe.

18. The food preparation system of claim 10 wherein the blade of the swiper is beveled to facilitate removal of food and food waste from the antimicrobial cutting board.

19. The food preparation system of claim 10 wherein the cutting tool is coupled to the swiper by male/female connectors.

20. The food preparations system of claim 10 further comprising grooves in the top surface of the antimicrobial cutting board that facilitate partial or complete removal of the slidable trays from their storage position.
